(19) United States
(12) Patent Application Publication
(10) Pub. No.: US 2004/0216087 A1
(43) Pub. Date: Oct. 28, 2004

(54) System and method for integrating object-oriented models and object-oriented programming languages

(76) Inventors: Kirk D. Wilson, Sugar Hill, NH (US); Christopher X. Condit, San Francisco, CA (US); It-Beng Tan, Redwood City, CA (US)

Correspondence Address: BAKER BOTTS L.L.P., 2001 ROSS AVENUE, SUITE 600, DALLAS, TX, 75201-2980, US

(21) Appl. No.: 10/421,998

(22) Filed: Apr. 22, 2003

(51) Int. Cl. G06F 9/44

(52) U.S. Cl. 717/116

(57) ABSTRACT

A method includes receiving a modeling template. The method further includes parsing the modeling template into a plurality of modeling constructs. Source code in an object-oriented programming language is automatically generated based, at least in part, on the plurality of modeling constructs, the object-oriented programming language comprising an object-oriented programming language with embedded inferencing.

### TECHNICAL FIELD

This disclosure relates generally to the field of computer systems, and more particularly to a system and method for integrating object-oriented models and object- oriented programming languages.

### BACKGROUND

Complex software systems are often developed and analyzed based on models created by a modeling language. Modeling languages allow a developer of the complex system to visualize and create various models of the components included in the complex system. Conventional modeling languages include object-oriented modeling languages such as, for example, Unified Modeling Language (UML). These modeling languages aid in comprehending complex systems.

Modeling templates may be generated for exchanging models created in the modeling language. These modeling templates are often created using template languages. Traditionally, modeling templates are used as a model interchange between modeling applications.

### SUMMARY

This disclosure provides a system and method for integrating object-oriented models and object-oriented programming languages.

In one embodiment, a method includes receiving a modeling template. The method further includes parsing the modeling template into a plurality of modeling constructs. Source code in an object-oriented programming language is automatically generated based, at least in part, on the plurality of modeling constructs, the object-oriented programming language comprising an object-oriented programming language with embedded inferencing.

In another embodiment, a method includes receiving source code, the source code substantially written in an object-oriented programming language with embedded inferencing. The method also includes parsing the source code into a plurality of object-oriented constructs. A modeling template is automatically generated based, at least in part, on the plurality of object-oriented constructs, the modeling template comprising an XML Metadata Interchange (XMI) document.

### BRIEF DESCRIPTION OF THE DRAWINGS

For a more complete understanding of this disclosure, reference is now made to the following descriptions, taken in conjunction with the accompanying drawings, in which:

FIG. 1 is an exemplary block diagram illustrating an example system for integrating object-oriented models and object-oriented programming languages according to one embodiment of this disclosure;

FIG. 2 is an exemplary diagram illustrating an example modeling association according to one embodiment of this disclosure;

FIG. 3 is an exemplary diagram illustrating an example mapping ruleset according to one embodiment of this disclosure;

FIGS. 4A-B are exemplary flow diagrams illustrating an example method for defining object-oriented constructs based on a modeling template according to one embodiment of this disclosure; and

FIGS. 5A-C are exemplary flow diagrams illustrating an example method for defining modeling constructs based on object-oriented source code according to one embodiment of this disclosure.

### DETAILED DESCRIPTION OF EXAMPLE EMBODIMENTS

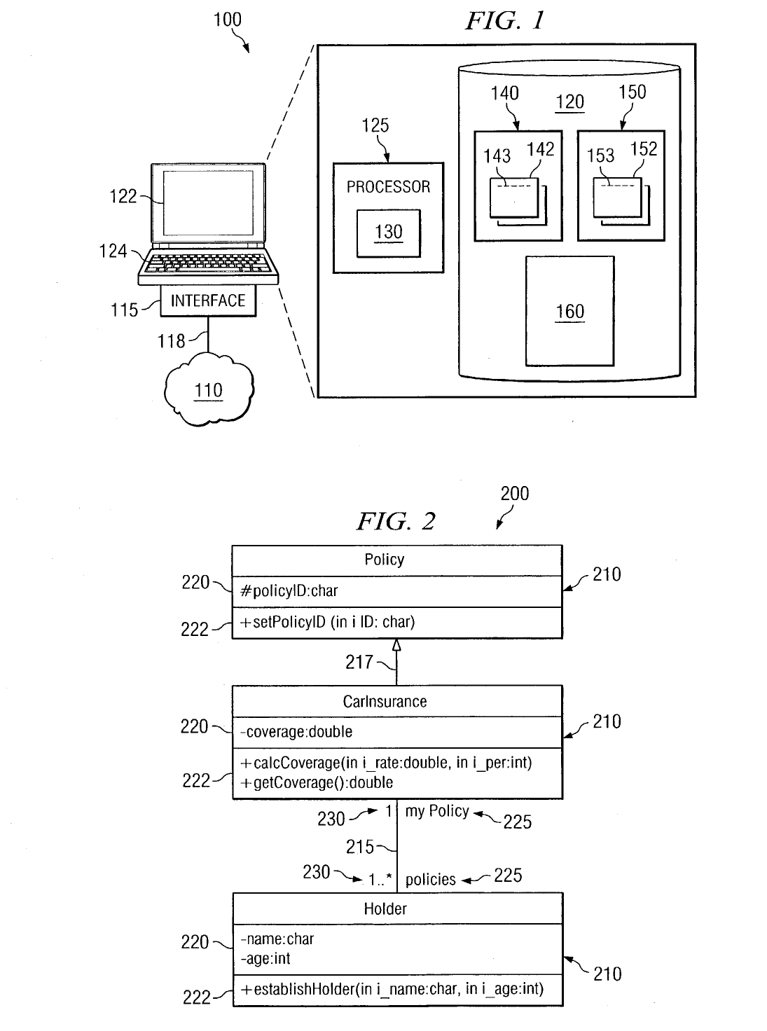

FIG. 1 illustrates a computing system 100 for integrating object-oriented models and object-oriented programming languages through mapping constructs of each. In general, integration of object-oriented models with object-oriented programming languages with embedding inferencing includes mapping, interfacing, communicating, or any other suitable processing operable to map from one type of construct to the other. Accordingly, computer 100 may comprise a portion of an information management system that maps modeling constructs 143 with object- oriented constructs 153 to generate object-oriented source code modules 152 or modeling template 142. It should be understood that mapping includes at least defining object-oriented source code modules 152 based on modeling constructs 143 and defining modeling template 142 based on object-oriented constructs 153.

Computer system 100 includes memory 120, processor 125, display 122, and keyboard 124. The present disclosure includes mapping engine 130, modeling templates 142, and object-oriented modules 152 that may be stored in memory 120 and may be executed or processed by processor 125. FIG. 1 only provides one example of a computer that may be used with the disclosure . The present disclosure contemplates computers other than general purpose computers as well as computers without conventional operating systems. As used in this document, the term “computer” is intended to encompass a personal computer, workstation, network computer, or any other suitable processing device. Computer system 100 may be adapted to execute any operating system including UNIX, Windows or any other operating system.

Computer 100 may also include an interface 115 for communicating with other computer systems over network 110 such as, for example, in a client-server or other distributed system via link 118. In certain embodiments, computer 100 receives modeling templates 142 and/or object-oriented modules 152 from network 110 for storage in memory 120. Network 110 facilitates wireless or wireline communication between computer system 100 and any other computer. Network 110 may communicate, for example, Internet Protocol (IP) packets, Frame Relay frames, Asynchronous Transfer Mode (ATM) cells, voice, video, data, and other suitable information between network addresses. Network 110 may include one or more local area networks (LANs), radio access networks (RANs), metropolitan area networks (MANs), wide area networks (WANs), all or a portion of the global computer network known as the Internet, and/or any other communication system or systems at one or more locations. Generally, interface 115 comprises logic encoded in software and/or hardware in a suitable combination and operable to communicate with network 110 via link 118. More specifically, interface 115 may comprise software supporting one or more communications protocols associated with link 118 and communications network 110 hardware operable to communicate physical signals. Memory 120 may include any memory or database module and may take the form of volatile or non-volatile memory including, without limitation, magnetic media, optical media, random access memory (RAM), read-only memory (ROM), removable media, or any other suitable local or remote memory component. In this embodiment, memory 120 includes modeling template table 140, object-oriented module table 150, and mapping ruleset 160. Memory 120 may include any other suitable data.

Modeling template table 140 stores one or more modeling templates 142. Modeling template table 140 may receive modeling template 142 via interface 115 or from another process running on computer 100. Table 140 may be of any suitable format including XMI documents, flat files, comma-separated-value (CSV) files, relational database tables, and others. Modeling template 142 includes any file or module that describes a model 200 (described in FIG. 2) and is operable to be processed by system 100. According to certain embodiments, received modeling template 142 may be generated by any modeling application operable to process model 200 and output a generic modeling template 142. For example, modeling template 142 may be generated in eXtensible Markup Language (XML) Metadata Interchange, or XMI, based on the Unified Modeling Language, or UML. A portion of an example modeling template 142 in XMI is illustrated below. It should be understood that this example is for illustrative purposes only and that any template language in any suitable format may be used without departing from the scope of this disclosure.

<Class name=“Student” xmi.id=“_13” isActive=“false” isRoot=“false”
isLeaf=“false” isAbstract=“false” visibility=“public”>

<features>
<Attribute name=“name” xmi.id=“_14”

ownerScope=“instance”
visibility=“protected” changeable=“none”
targetScope=“instance” type=“String”
type_Type=“DataType” />

. . .
<Class name=“PartTime” xmi.id=“_6” isActive=“false” isRoot=“false”
isLeaf=“false” isAbstract=“false” visibility=“public”>

<generalizations>
<Generalization xmi.id=“_7” parent=“Student”

parent_Type=“Class” visibility=“public” />

</generalizations>

</Class>

Modeling template 142 includes modeling constructs 143. Modeling construct 143 is an architectural element defined within the appropriate template language and used to generate the fundamental object-oriented constructs 153 based on mapping ruleset 160. Modeling constructs 143 may include modeling class constructs with metaattributes, modeling association constructs, modeling operation constructs, modeling attribute constructs, or any other suitable modeling construct. Each modeling construct 143 may be independent, a child of another construct 143, and/or reside within another construct 143. For example, using the exemplary portion of modeling template 142 above, modeling class construct “Student” includes at least five metaattributes: “is Active”, “is Root”, “is Leaf”, “is Abstract”, and “visibility” and one modeling attribute construct “Attribute”. Further, example modeling class construct “Student” is associated with a child modeling class construct “Part-Time” through a relationship of Generalization

Object-oriented module table 150 includes one or more object-oriented modules 152, each of which is source code written in an object-oriented language with embedded inferencing. Although FIG. 1 illustrates memory 120 including object-oriented module table 150, it will be understood that object-oriented module table 150 may reside locally in memory 120 or remotely on another computer or server. Object-oriented module table 150 includes any software or logic operable to be parsed into object-oriented constructs 153 such as, for example, object-oriented classes, methods, attributes, and interfaces. Each object-oriented module 152 may be written in any appropriate object-oriented computer language with embedded inferencing. It will be understood that embedded inferencing includes the ability to inference as a feature of the semantics of the object-oriented language. The object- oriented language would then inherently support inferencing over rules. In short, embedded inferencing enables object-oriented languages to support inferencing over rules without the incorporation of additional object structures such as, for example, an instantiation of an inference engine accessed through an application program interface (API).

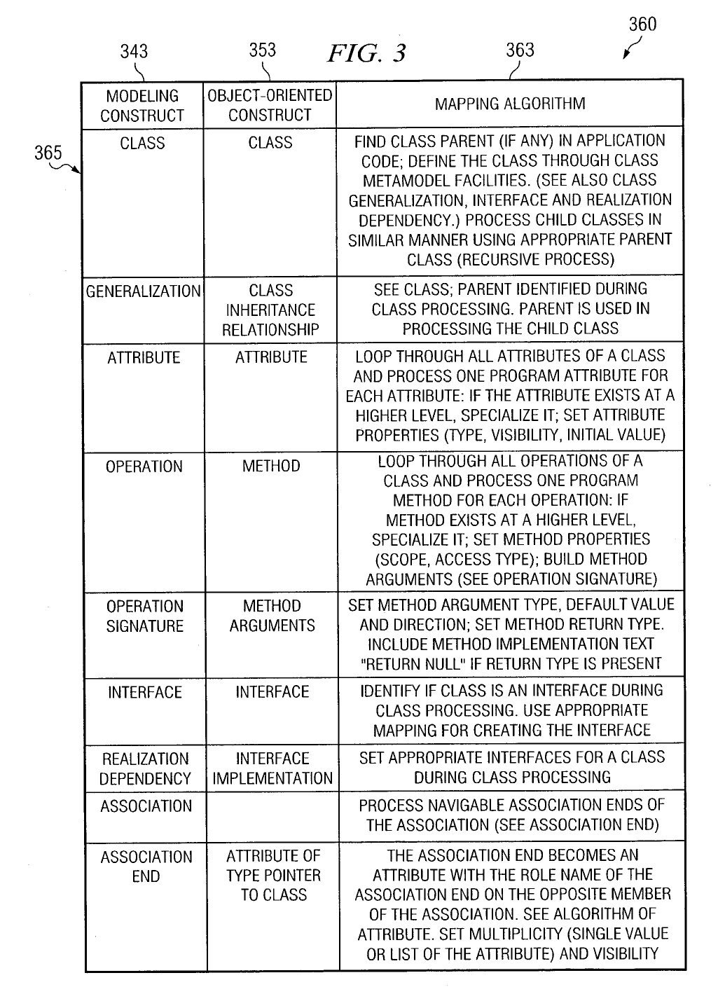

As described in more detail in FIG. 3, mapping ruleset 160 provides mapping engine 130 various techniques for mapping modeling constructs 143 with object-oriented constructs 153. Ruleset 160 comprises instructions, algorithms, mapping tables, arrays, or any other set of directives or datums which largely allows for efficient and accurate integration between modeling templates 142 and object-oriented modules 152. Although FIG. 1 illustrates mapping ruleset 160 as residing internally to memory 120, mapping ruleset 160 may reside externally at one or more computers or internally to mapping engine 130 without departing from the scope of this disclosure.

Processor 125 executes instructions and manipulates data to perform the operations of computer 100, such as mapping engine 130. Although FIG. 1 illustrates a single processor 125 in computer 100, multiple processors 125 may be used and reference to processor 125 is meant to include multiple processors 125 where applicable. In the embodiment illustrated, computer 100 includes mapping engine 130 that integrates modeling constructs 143 and object-oriented constructs 153. Mapping engine 130 could include any hardware, software, firmware, or combination thereof operable to integrate modeling templates 142 and object-oriented modules 152. It will be understood that while mapping engine 130 is illustrated as a single multi-tasked module, the features and functionality performed by this engine may be performed by multiple modules such as, for example, an interpreter module and a generation module. In one embodiment, mapping engine 130 parses modeling template 142 into modeling constructs 143 and automatically generates object- oriented source code 152 based on modeling constructs 143. In another embodiment, mapping engine 130 parses object-oriented modules 152 into object-oriented constructs 153 and automatically generates modeling template 142 based on object- oriented constructs 153. Mapping engine 130 may use any appropriate technique to parse modeling templates 142 into modeling constructs 143 such as, for example, document object modeling (DOM) or to parse object-oriented modules 152 into object-oriented constructs 153. The term “automatically,” as used herein, generally means that the appropriate processing is substantially performed by system 100. It should be understood that automatically further contemplates any suitable user interaction with system 100.

In one aspect of operation, memory 120 receives a modeling template 142. As described above, modeling template 142 may be received from any appropriate component, internal or external, including, for example, from another computer via network 110. Upon receiving modeling template 142, mapping engine 130 loads modeling template 142 and mapping ruleset 160. Mapping engine 130 then parses modeling template 142 into one or more modeling constructs 143. As described above, modeling constructs 143 may include modeling class constructs, modeling association constructs, or any other suitable modeling construct. Once modeling template 142 is parsed into various modeling constructs 143, mapping engine 130 defines one or more object-oriented (or programming) constructs 153 based on the modeling constructs 143 using modeling ruleset 160. Once mapping engine 130 has processed all of the modeling constructs 143 from parsed modeling template 142 and, subsequently, defined one or more object-oriented constructs 153, mapping engine 130 automatically generates one or more object-oriented source code modules 152. According to certain embodiments, mapping engine may define object-oriented constructs 153 by loading data structures, combining the definition and generation steps, or any other suitable processing.

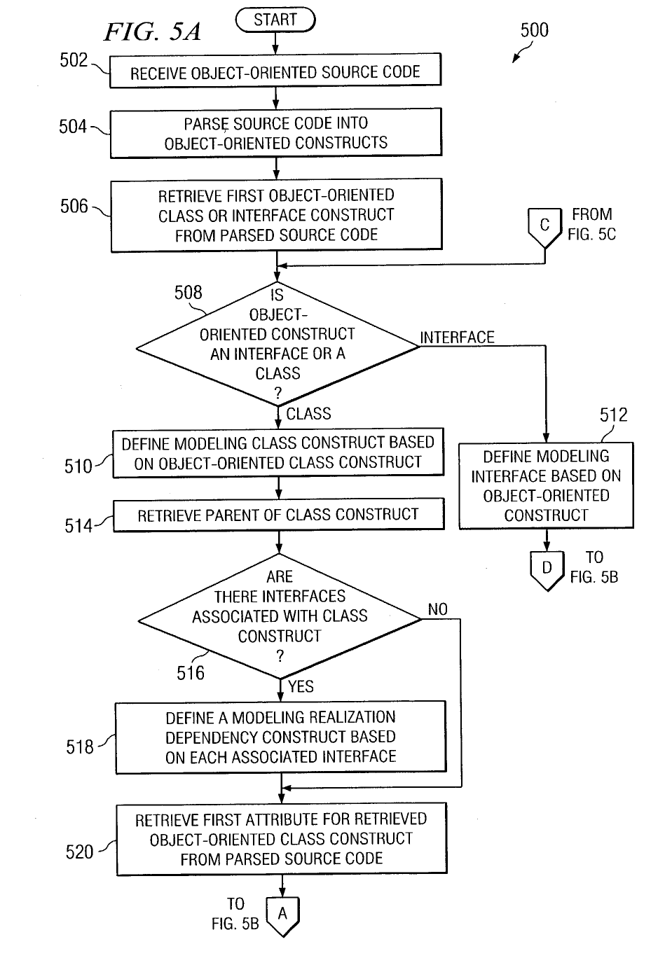

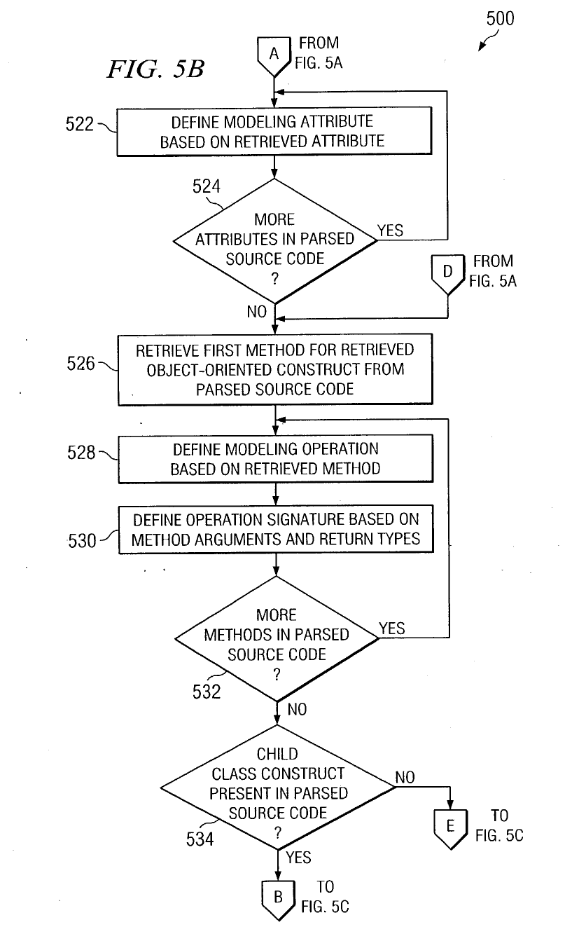

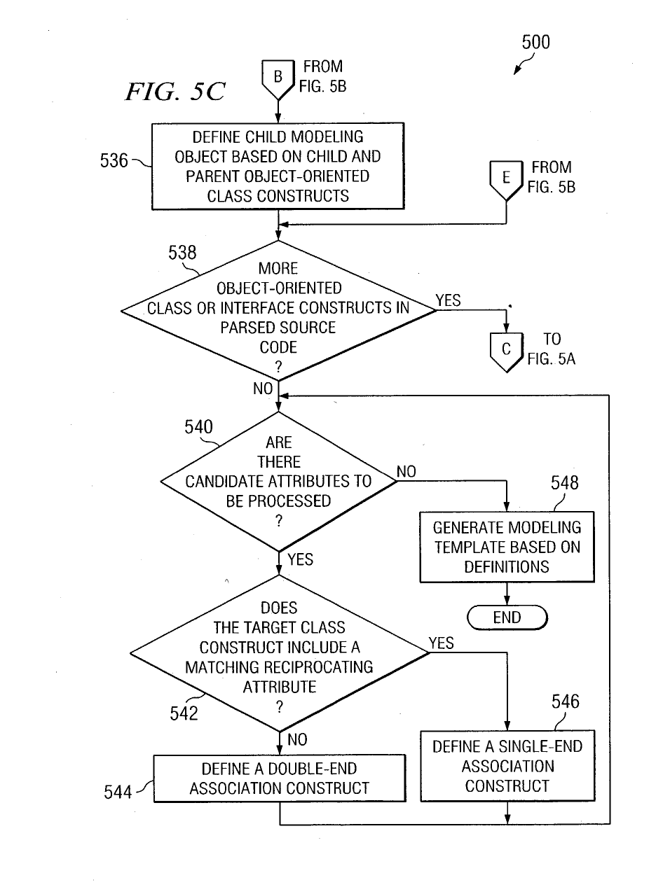

In addition, while not explicitly described in FIG. 1, the operation and arrangement of elements within mapping engine 130 will depend upon the particular mapping techniques requested by computer 100. That is, mapping engine 130 may, alternatively or in combination, function to generate a modeling template 142 based on object-oriented source code modules 152 without departing from the scope of this disclosure. Accordingly, as described in more detail in FIGS. 5A-C, system 100 contemplates mapping engine 130 having any suitable combination and arrangement of hardware, software, algorithms, and/or controlling logic that operates to generate modeling template 142 based on object-oriented source code 152.

FIG. 2 is an exemplary diagram illustrating an example object-oriented model 200 according to one embodiment of this disclosure. In general, model 200 can represent a logical object-oriented model of a software system or metamodel (not shown). Model 200 may include any number of architectural elements and may be described using any language or format such as, for example, UML or any other suitable modeling language. For example, model 200 may conform to the OMG Unified Modeling Language Specification. Computer 100 contemplates receiving any modeling template 142, which generically describes elements of model 200, such that mapping engine 130 may generate source code in an object-oriented programming language with embedded inferencing.

According to certain embodiments, at the highest logical level example model 200 includes classes 210, association 215, and generalization 217. Class 210 may include any set of elements that share substantially identical attributes 220, interfaces (not shown), or operations 222 as appropriate. Class 210 may include one or more instances. As described below, various classes 210 may also inherit attributes 220 and/or operations 222 from another class 210. Attribute 220 comprises a variable that may be stored in instances of class 210. Each attribute 220 may include a variable type and an initial value. Operation 222 represents any method or service that may be requested of class 210. Each operation 222 may include operation signatures that define operation parameters and any directions. Example model 200 includes three classes 210: “Policy,” “CarInsurance,” and “Holder.” First class 210 “Policy” includes attribute 220 “policy ID” and operation 222 “setPolicyID.” Second class 210 “CarInsurance” includes attribute 220 “policy ID” and operations 222 “calcCoverage” and “getCoverage.” Third class 210 “Holder” includes attributes 220 “name” and “age” and operation 222 “establishHolder.”

One or more classes 210 may be associated through association 215. Association 215 generally describes a semantic relationship that includes at two association ends, each association end normally comprising a class 210. It should be understood that the plurality of association ends may be one instance of class 210 in relation to another instance of the same class 210. Each illustrated association 215 includes two names 225 and two association metaattributes 230. Name 225 identifies the respective target instance to the source instance. Association metaattributes 230 may include navigability (allows traversal from source to target), multiplicity (number of allowable target instances), visibility (visibility of target instance to source), aggregation (target is an aggregation of source), ordering (target instances are viewed as ordered to source instance), changeability (source instance can change target instance), and any other suitable association metaattribute. For example, model 200 includes association 215 with two association ends: classes 210 “CarInsurance” and “Holder.” In this example, when “Holder” is the source instance, then association name 225 of “CarInsurance” is “my Policy” with a multiplicity attribute 225 of one (1). When “CarInsurance” is the source, then “Holder” is the target with association name 225 “policies” and a multiplicity attribute 225 of one or more (1 . . . *).

Generalization 217 illustrates a taxonomic relationship between a parent class 210 and a child class 210. In certain embodiments, generalization 217 illustrates that child class 210 inherits attributes from parent class 210. Returning to example model 200, “CarInsurance” is a child of “Policy.” In short, “CarInsurance” is a specialized form of “Policy” and, therefore, includes parent attribute 220 “policyID” and parent operation 222 “setPolicyID” as well as its own attribute 220 “coverage” and operations 222 “calcCoverage” and “getCoverage.”

In one aspect of operation, computer 100 generates modeling template 142 based on model 200 using any appropriate technique and template language. One example technique includes generating one modeling class construct based on each class 210. Once modeling class constructs are generated, modeling attribute constructs and modeling operation constructs are generated for the particular modeling class construct based on attributes 220 and operations 222 from class 210, respectively.

It should be understood that FIG. 2 illustrates merely one example of model 200. System 100 contemplates model 200 including any number of elements in any order or layout. Further, model 200 may be written or developed in any modeling language without departing from the scope of this disclosure. It will be further understood that any computer using any suitable software or logic may generate modeling template 142, in any appropriate template language, based on model 200.

FIG. 3 is an exemplary diagram illustrating an example mapping ruleset 360 in accordance with one embodiment of computer system 100. Generally, mapping ruleset 360 provides mapping engine 130 with rules, algorithms, or other directives for mapping modeling constructs 143 with object-oriented constructs 153.

Mapping ruleset 360 may illustrate a software module, logic, a data structure, or any combination thereof. For illustrative purposes only, example mapping ruleset 360 is a multi-dimensional data structure that includes at least one mapping instruction 365. Each mapping instruction 365 includes multiple columns. In this example, mapping instruction 365 includes a modeling construct field 343, an object-oriented construct field 353, and a mapping algorithm 363. It will be understood that each mapping instruction 365 may include none, some, or all of the example columns. In one embodiment, mapping instruction 365 may include a link to another table, such as, for example, modeling construct field 343 may be used to access particular modeling constructs 143 in modeling template 142. It should be noted that mapping instruction 365 may be accessed by modeling construct field 343, object-oriented construct field 353, or any other field. For example, mapping engine may use modeling construct 143 as a key into mapping ruleset 360 using the modeling construct field 343.

Example mapping ruleset 360 includes mapping algorithms for a number of modeling constructs 343 and/or object-oriented constructs 353. For example, mapping instructions 365 include “class,” “generalization,” “attribute,” “operation,” “operation signature,” “interface,” “realization,” “association,” and “association end” modeling constructs 343. In certain embodiments, each modeling construct 343 represents one UML architectural element, as illustrated above in FIG. 2. Example mapping instructions 365 also include “class,” “class inheritance,” “attribute,” “method,” “method arguments,” “interface,” “interface implementation,” and “pointer” object-oriented constructs 353. Each object-oriented construct 353 may represent an object-oriented element of the same or similar name in any appropriate object-oriented language. Mapping algorithms 363 illustrate the logic or algorithm used by mapping engine 130 to map modeling constructs 143 with object-oriented construct 153 as described in more detail in the following flowcharts.

The following flowcharts focus on the operation of example computer system 100 and mapping engine 130 described in FIG. 1, as this diagram illustrates functional elements that provide for the preceding integration techniques. However, as noted, system 100 contemplates using any suitable combination and arrangement of functional elements for providing these operations, and these techniques can be combined with other techniques as appropriate. Further, various changes may be made to the following flowcharts without departing from the scope of this disclosure. For example, any or all of the steps may be performed automatically by system 100.

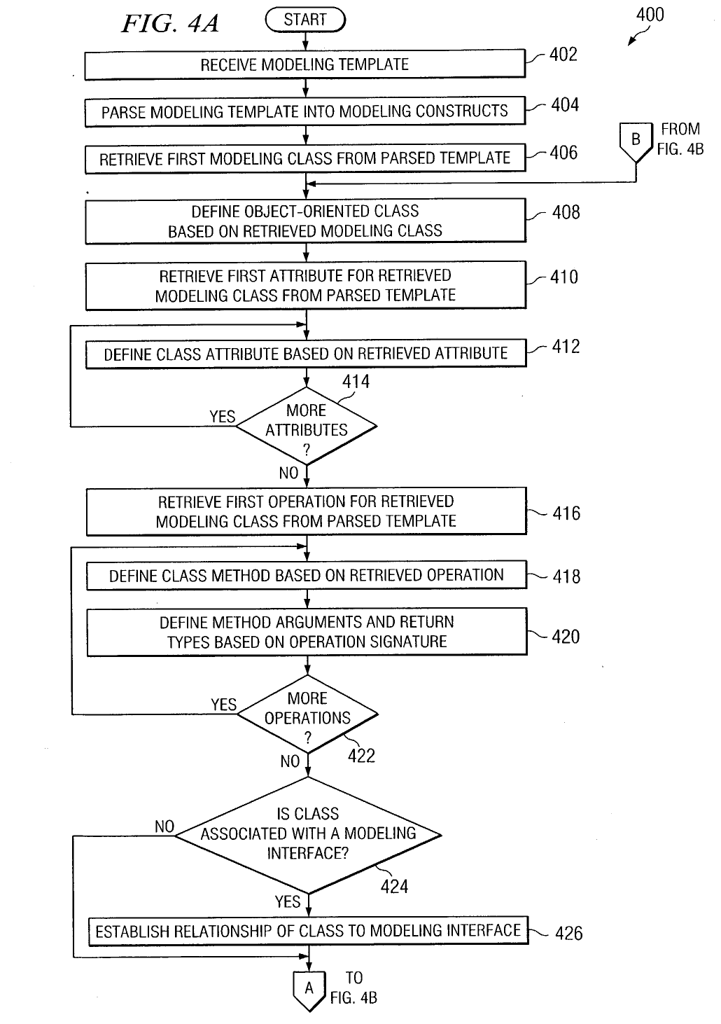

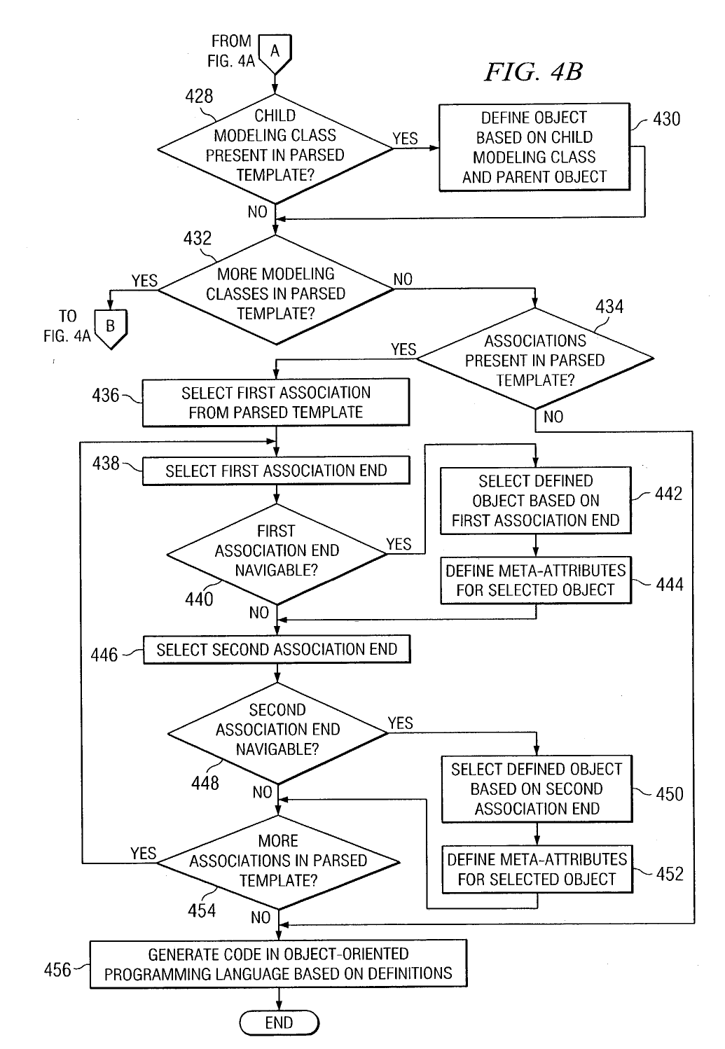

FIGS. 4A-B are exemplary flow diagrams illustrating an example method 400 for defining object-oriented constructs 153 based on a modeling template 142 according to one embodiment of this disclosure. Method 400 may be described with respect to system 100 of FIG. 1. Method 400 could also be used by any other suitable system.

Computer 100 receives modeling template 142 at step 402. According to one embodiment, mapping engine 130 receives modeling template 142 from modeling template table 140 in memory 120. As described above, computer 100 may receive modeling template from one or more computers via network 110. Mapping engine 130 parses modeling template 142 into one or more modeling constructs 143 at step 404. This may include, for example, mapping engine 130 identifying modeling class constructs, modeling association constructs, modeling attribute constructs, and modeling operation constructs. As described above, mapping engine 130 may use any appropriate technique to parse modeling templates 142 into modeling constructs 143 such as, for example, document object modeling (DOM). At step 406 mapping engine 130 retrieves first modeling class construct from the parsed modeling template 142. Next, in step 408 through step 432, mapping engine 130 processes the plurality of modeling constructs 143 and defines one or more object-oriented constructs 153 on a class-by-class basis.

Mapping engine 130 defines an object-oriented class construct based on the retrieved modeling class construct, including its metaattributes, at step 408. According to certain embodiments, mapping engine 130 may use modeling class construct as a key into mapping ruleset 360 to obtain the desired algorithm 363 for substantially defining object-oriented class construct. Further, mapping engine 130 may also determine if the retrieved modeling class construct has a parent class or interface and, accordingly, define attributes for the object-oriented class based on the parent. Then, in steps 410 through 414, mapping engine 130 processes one or more attribute constructs for each modeling class construct. For example, at step 410 mapping engine 130 retrieves a first attribute for retrieved modeling class construct from the parsed modeling template 142. Mapping engine 130 defines an object- oriented attribute construct based on the retrieved modeling attribute construct at step 412. According to certain embodiments, mapping engine 130 may use modeling attribute construct as a key into mapping ruleset 360 to obtain the desired algorithm 363 for substantially defining object-oriented attribute construct. Part of the definition of an object-oriented attribute construct may also include setting attribute properties such as, for example, type, visibility, initial value, or any other appropriate property for an object-oriented attribute. At decisional step 414, mapping engine 130 determines if there are more modeling attributes for the retrieved modeling class construct. If, at decisional step 414, mapping engine 130 determines that there are more modeling attributes, then mapping engine 130 retrieves the next attribute construct for the retrieved modeling class construct and processing returns to step 412. Once there are no remaining modeling attribute constructs for the retrieved modeling class construct, processing proceeds to step 416.

Once all the attributes for the retrieved modeling class construct have been processing, mapping engine 130 retrieves a first modeling operation construct for the retrieved modeling class construct at step 416. At step 418 mapping engine 130 defines an object-oriented method construct for the object-oriented class construct based on the retrieved modeling operation construct. According to certain embodiments, mapping engine 130 may use modeling operation construct 143 as a key into mapping ruleset 360 to obtain the desired algorithm 363 for substantially defining object-oriented method construct. Part of this method definition may also include mapping engine 130 setting method properties such as, for example, scope or access type. Mapping engine 130 then defines method arguments and return types based on the operation signature at step 420. At step 420, mapping engine 130 may also set default values and direction for the method. Mapping engine 130 may further define method implementation text “return NULL” if a return type is present. At decisional step 422, mapping engine 130 determines if there are more operations in the retrieved modeling class construct. If mapping engine 130 determines that there are more modeling operation constructs, then processing returns to step 418. Once all the objects in the retrieved modeling class construct have been processed, execution proceeds to step 424.

Mapping engine 130 determines if the object-oriented class construct is associated with a modeling interface at decisional step 424. If the object-oriented class construct is associated with an interface, then mapping engine 130 establishes the relationship of the object-oriented class construct to the modeling interface at step 426. Next, or if the object-oriented class construct is not associated with an interface, mapping engine 130 determines if there is a child modeling class construct present in parsed modeling template 142 at decisional step 428. If there are child modeling class constructs present, then mapping engine 130 defines object-oriented class constructs based on the child modeling class constructs and parent object-oriented class constructs. In certain embodiments, this definition of child object-oriented class construct uses techniques substantially similar to those defined in steps 408 through 432. At decisional step 432, mapping engine 130 determines if there are more modeling class constructs remaining in parsed modeling template 142. If there are more modeling class constructs, then mapping engine 130 retrieves the next modeling class construct and processing returns to step 408. Otherwise, mapping engine 130 processes any modeling association constructs present in parsed modeling template 142 in steps 434 through 454.

If no associations are present in modeling template 142, then processing proceeds to step 456. Otherwise, mapping engine 130 processes all the associations in template 142. At step 436, mapping engine 130 selects a first association construct from modeling template 142. Then, in steps 438 through 452, mapping engine 130 processes both ends, or class constructs, of the selected association. At step 438, mapping engine 130 selects a first association end. At decisional step 440 mapping engine 130 determines if the first association end is navigable. If the first association end is not navigable, mapping engine 130 then proceeds to process the second association end beginning at step 446. If the first association end is navigable then mapping engine 130 selects the defined class construct based on the first association end at step 442. At step 444, mapping engine then defines an object-oriented attribute construct for the selected class construct based on various metaattributes of the association end. At step 446, mapping engine 130 selects a second association end. At decisional step 448, mapping engine 130 determines if the second association end is navigable. If the second association end is not navigable, then execution proceeds to step 454. Otherwise, mapping engine 130 selects the defined class construct based on the second association end at step 450. Mapping engine 130 then defines an object oriented attribute construction for the selected class construct based upon metaattributes in the second association end at step 452. At decisional step 454, mapping engine 130 determines if there are more associations in modeling template 142. If there are more associations, then mapping engine 130 selects the next association from modeling template 142 and processing returns to step 438. Once all of the associations in modeling template 142 have been processed, processing proceeds to step 456. At step 456, mapping engine 130 generates one or more object-oriented modules 152 in an object-oriented programming language with embedded inferencing based on the object-oriented constructs 153 defined using the above techniques. As described above in relation to FIG. 1, any suitable object-oriented language may be used.

Although FIGS. 4A-B illustrates one example of a method 400 for defining object-oriented constructs 153 based on a modeling template 142, various changes may be made to FIGS. 4A-B. For example, computer 100 may use any other type of modeling template 142 written in any suitable language. Also, while FIGS. 4A-B illustrate mapping engine 130 receiving modeling template 142 from memory 120, mapping engine 130 could receive modeling template 142 directly from network 110 via interface 115.

FIGS. 5A-C are exemplary flow diagrams illustrating an example method 500 for defining modeling constructs 143 based on object-oriented source code 152 according to one embodiment of this disclosure. Method 500 may be described with respect to system 100 of FIG. 1. Method 500 could also be used by any other suitable system.

Computer 100 receives object-oriented source code at step 502. For example, memory 120 may receive one or more source code modules written in an object- oriented programming language with embedded inferencing from network 110 via interface 115. Mapping engine 130 may then load the various source code modules 152 and mapping ruleset 160. At step 504, mapping engine 130 parses the source code into one or more object-oriented constructs 153. At step 506, mapping engine 130 retrieves a first object-oriented class construct or interface construct from the parsed source code. Then, in step 508 to step 538, mapping engine 130 processes the one or more object-oriented class or interface constructs to define one or more modeling constructs 143.

Once object-oriented class or interface construct 153 has been retrieved, mapping engine 130 determines if the retrieved construct is a class or an interface at step 508. If construct 153 is a class, then mapping engine 130 defines a modeling class construct and its metaattributes based on the object-oriented class construct and its properties at step 510. According to certain embodiments, mapping engine 130 may use object-oriented class construct as a key into mapping ruleset 360 to obtain the desired algorithm 363 for substantially defining modeling class construct 143. If construct 153 is a class, mapping engine 130 may also determine if the retrieved object-oriented class construct has a parent class and, accordingly, define attributes for the modeling class based on the parent at step 514. At decisional step 516, mapping engine 130 determines if there are any interfaces associated with the object- oriented class construct. If there are, then mapping engine 130 defines a modeling realization dependency based on each interface at step 518. Mapping engine 130 retrieves a first attribute for the retrieved object-oriented class construct at step 520. At step 522, mapping engine 130 defines a modeling attribute construct for modeling construct based on the object-oriented attribute construct retrieved for the object- oriented class construct. According to certain embodiments, mapping engine 130 may use object-oriented attribute construct as a key into mapping ruleset 360 to obtain the desired algorithm 363 for substantially defining modeling attribute construct 143. At decisional step 524, mapping engine 130 determines if there are more attributes for the retrieved object-oriented class construct. If there are more attributes, mapping engine 130 retrieves the next attribute for the object-oriented class construct and processing returns to step 522. Returning to decisional step 508, if mapping engine determined that the retrieved object-oriented construct was an interface, then mapping engine 130 defines a modeling interface based on the retrieved object-oriented interface construct at step 512. Once there are no more attributes for the object- oriented class construct at step 524 or the interface construct was defined at step 512, processing proceeds to step 526 through step 532 where mapping engine 130 processes various methods for the object-oriented class or object-oriented interface construct.

At step 526, mapping engine 130 retrieves a first object-oriented method construct for the object-oriented class or interface construct. Mapping engine 130 defines a modeling operation construct for modeling class or interface construct based on the retrieved class method construct at step 528. According to certain embodiments, mapping engine 130 may use the object-oriented method construct as a key into mapping ruleset 360 to obtain the desired algorithm 363 for substantially defining modeling operation construct 143. Next, mapping engine 130 defines one or more operation signatures based on the method arguments and return types at step 530. At decisional step 532, mapping engine 130 determines that there are more methods in the parsed source code from the object-oriented class or interface construct. If there are more methods, mapping engine 130 retrieves the next method for the object-oriented class or interface construct and processing returns to step 528. Once all the methods for the object-oriented constructs have been processed, processing proceeds to step 534.

At decisional step 534, mapping engine 130 determines if there are any child object-oriented class or interface constructs present in the parsed source code. If there are no child class or interface constructs then processing proceeds to step 538. If there are child object-oriented class or interface constructs, then mapping engine 130 defines a child modeling class or interface construct based on the child and parent object-oriented constructs 153 at step 536. At decisional step 538, mapping engine 130 determines if there are more object-oriented class or interface constructs in the source code parsed earlier at step 504. If there are more object-oriented class or interface constructs, then mapping engine 130 retrieves the next object-oriented construct and processing returns to step 508. Then, in steps 540 through 546, mapping engine 130 defines modeling associations based on the object-oriented source code.

At decisional step 540, mapping engine 130 determines if there are any candidate attributes to be processed. In certain embodiments, this may include processing a saved attribute file (not shown) that stores candidate attributes, which are attributes of a type equal to a reference to another class construct, during attribute processing; although, any appropriate technique may be used. If there are any candidate attributes, then mapping engine 130 determines if the target class construct of each attribute includes a matching reciprocating attribute at decisional step 542. If the target class construct includes a matched attribute, then mapping engine 130 creates an association construct in which both ends are navigable ends at step 544. Otherwise, mapping engine 130 creates a directed association construct, in which one end is a non-navigable end. At step 548, once all the object-oriented constructs have been processed, then mapping engine 130 generates at least one modeling template 142 based on the plurality of modeling constructs 143 defined using the example techniques described above.

Although FIGS. 5A-C illustrate one example of a method 500 for defining modeling constructs 143 based on object-oriented source code, various changes may be made to FIGS. 5A-C. For example, any object-oriented language with embedded inferencing may be used. Further, any type of source code written in the appropriate object-oriented language with embedded inferencing may be used such as, for example, modules, libraries, or any other suitable piece of source code. Also, while FIGS. 5A-C describe mapping engine 130 receiving an object-oriented module 152 from memory 120, mapping engine 130 could receive object-oriented module 152 directly from network 110 via interface 115.

While this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method, comprising:
receiving a modeling template;
parsing the modeling template into a plurality of modeling constructs; and
automatically generating object-oriented source code with embedded inferencing based, at least in part, on the plurality of modeling constructs.

2. The method of claim 1 further comprising:
defining one or more object-oriented constructs based, at least in part, on the parsed modeling constructs; and
automatically generating the object-oriented source code with embedded inferencing based, at least in part, on the defined object-oriented constructs.

3. The method of claim 2, the modeling constructs comprising modeling class constructs, modeling attribute constructs, and modeling operation constructs, and the object-oriented constructs comprising object-oriented classes, wherein defining one or more object-oriented constructs based, at least in part, on the parsed modeling constructs comprises:
defining at least one object-oriented class based on one of the modeling class constructs;
defining at least one attribute of the one or more object-oriented classes based on one of the modeling attribute constructs; and
defining at least one method in the one or more object-oriented classes based on one of the modeling operation constructs.

4. The method of claim 3 further comprising defining at least one argument for the one or more methods based on each operation signature in the modeling operation construct.

5. The method of claim 3, the modeling class construct comprising an interface and the method further comprising defining an object-oriented interface for the one or more object-oriented classes based on the modeling class construct.

6. The method of claim 3 further comprising defining one attribute of one or more of the object-oriented classes based on a modeling association construct in the modeling template.

7. The method of claim 6 further comprising:
selecting one object-oriented class based on a first end of the association, the first end being navigable;
defining one attribute of the selected object-oriented class based on the first navigable end of the association;
selecting one object-oriented class based on a second end of the association, the second end being navigable; and
defining one attribute of the selected object-oriented class based on the second navigable end of the association.

8. The method of claim 3 further comprising defining an object-oriented class as a child of one of the defined object-oriented classes based, at least in part, on one of the modeling class constructs.

9. The method of claim 1, the modeling template comprising an XML Metadata Interchange (XMI) document.

10. A system, comprising:
a memory operable to store a modeling template; and
one or more processors collectively operable to:
parse the modeling template into a plurality of modeling constructs; and
automatically generate object-oriented source code with embedded inferencing based, at least in part, on the plurality of modeling constructs.

11. The system of claim 10, the one or more processors further collectively operable to:
define one or more object-oriented constructs based, at least in part, on the parsed modeling constructs; and
automatically generate the object-oriented source code with embedded inferencing based, at least in part, on the defined object-oriented constructs.

12. The system of claim 11, the modeling constructs comprising modeling class constructs, modeling attribute constructs, and modeling operation constructs, and the object-oriented constructs comprising object-oriented classes, the one or more processors further collectively operable to:
define at least one object-oriented class based on one of the modeling class constructs;
define at least one attribute of the one or more object-oriented classes based on one of the modeling attribute constructs; and
define at least one method in the one or more object-oriented classes based on one of the modeling operation constructs.

13. The system of claim 12, the one or more processors further collectively operable to define at least one argument for the one or more methods based on each operation signature in the modeling operation construct.

14. The system of claim 12, the modeling class construct comprising an interface and the one or more processors further collectively operable to define an object-oriented interface for the one or more object-oriented classes based on the modeling class construct.

15. The system of claim 12, the one or more processors further collectively operable to define one attribute of one or more of the object-oriented classes based on a modeling association construct in the modeling template.

16. The system of claim 15, the one or more processors further collectively operable to:
select one object-oriented class based on a first end of the association, the first end being navigable;
define one attribute of the selected object-oriented class based on the first navigable end of the association;
select one object-oriented class based on a second end of the association, the second end being navigable; and
define one attribute of the selected object-oriented class based on the second navigable end of the association.

17. The system of claim 12, the one or more processors further collectively operable to define an object-oriented class as a child of one of the defined object-oriented classes based, at least in part, on one of the modeling class constructs.

18. The system of claim 10, the modeling template comprising an XML Metadata Interchange (XMI) document.

19. Logic embodied on at least one computer readable medium and operable when executed to:
receive a modeling template;
parse the modeling template into a plurality of modeling constructs; and
automatically generate object-oriented source code with embedded inferencing based, at least in part, on the plurality of modeling constructs.

20. A system, comprising:
means for receiving a modeling template;
means for parsing the modeling template into a plurality of modeling constructs; and
means for automatically generating object-oriented source code with embedded inferencing based, at least in part, on the plurality of modeling constructs.

21. A method, comprising:
receiving object-oriented source code with embedded inferencing;
parsing the source code into a plurality of object-oriented constructs; and
automatically generating a modeling template based, at least in part, on the plurality of object-oriented constructs, the modeling template comprising an XML Metadata Interchange (XMI) document.

22. The method of claim 21 further comprising:
defining modeling constructs based, at least in part, on the parsed object- oriented programming constructs; and
automatically generating the modeling template based, at least in part, on the defined modeling constructs.

23. The method of claim 22, the modeling constructs comprising modeling class constructs and the object-oriented programming constructs comprising object-oriented classes, the method further comprising:
defining at least one modeling class construct based on one of the object- oriented classes;
defining at least one attribute of the one or more modeling class constructs based on an attribute in the object-oriented class; and
defining at least one operation in the one or more modeling class constructs based on a method in the object-oriented class.

24. The method of claim 23 further comprising defining at least one operation signature argument for the one or more modeling class construct based on one of the methods in the object-oriented class.

25. The method of claim 23, the method further comprising defining a modeling interface construct based on an object-oriented interface.

26. The method of claim 23 further comprising defining a modeling association based on at least one attribute of one or more object-oriented classes, the association comprising at least one navigable end.
